(19) United States
(12) Patent Application Publication
(10) Pub. No.: US 2008/0156909 A1
(43) Pub. Date: Jul. 3, 2008

(54) Method For Synthesizing Compounds

(75) Inventors: Ferdi Schuth, Mulheim an der Ruhr (DE); Borislav Bogdanovic, Mulheim an der Ruhr (DE); Michael Felderhoff, Essen (DE); Jose M Bellosta von Colbe, Hamburg (DE)

Correspondence Address: NORRIS, MCLAUGHLIN & MARCUS, PA, 875 THIRD AVENUE, 18TH FLOOR, NEW YORK, NY, 10022, US

(73) Assignee: STUDIENGESELLSCHAFT KOHLE MBH, Mülheim an der Ruhr (DE)

(21) Appl. No.: 11/817,998

(22) PCT Filed: Mar. 1, 2006
(86) PCT No.: PCT/DE06/00367

§ 371 Date: Sep. 7, 2007

(30) Foreign Application Priority Data
Mar. 9, 2005 (DE) 10 2005 010 700.1

(51) Int. Cl. B02C 19/00

(52) U.S. Cl. 241/25; 241/101.01

(57) ABSTRACT

A process is claimed for synthesizing compounds, in which solids are reacted with one or more gases, in which the solids are ground above atmospheric pressure in the presence of the gas. To perform the process, preference is given to using a mill with a grinding space (1) which accommodates the material being ground (10), and in which the grinding space (1) can be sealed in a pressure-tight manner even against high internal pressures (P₁).

The present invention relates to a process for synthesizing compounds, in which solids are reacted with one or more gases, especially to a process for preparing hydrogen storage materials in the form of complex metal aluminum hydrides, and also to a mill which is suitable for performing the process.

For the storage of hydrogen, nowadays, predominantly the methods of storage as a compressed gas in pressure vessels, at standard pressure in gasometers and at low temperatures (≦20 K) as liquid hydrogen are employed in industry.

The international patent application WO97/03919 discloses a process for reversibly storing hydrogen. This process should be employed especially for the use of hydrogen as an energy carrier (fuel). It is based on the reversible thermal dissociation of metal hydrides (MHₙ). Apart from H₂ storage for stationary or mobile applications, it is possible to use reversible metal hydride-metal systems industrially for a series of further potential or already implemented applications, such as hydrogen removal, hydrogen purification and compression, heat storage, heat conversion and cold generation (heat pumps) and as electrodes for electrical batteries.

MHₙ+heat [symbol] M+n/2H₂ (1)
M=metal, metal alloy, intermetallic compound

Reversible H₂ storage in the form of metal hydrides has several advantages over conventional storage methods. Compared to compressed H₂ gas, metal hydrides have considerable advantages in relation to the achievable volumetric storage density. Moreover, metal hydrides have the safety advantage that their hydrogen dissociation pressure, compared to the same concentration of hydrogen under pressure, is lower by several powers of ten. The volumetric H₂ densities achievable with hydride vessels approach those of liquid hydrogen vessels without any need to make use of costly, complicated cryotechnology. The disadvantages of the latter can be seen, inter alia, in the fact that, to recover one energy unit of liquid hydrogen, 2.5 to 5 times the primary energy expenditure is required.

The storage materials used in WO97/03919 are mixtures of aluminum metal with alkali metals and/or alkali metal hydrides. The starting components are prepared by reacting aluminum metal with alkali metal or alkaline earth metal and/or hydrides thereof in the presence of hydrogen.

WO01/68515 discloses a further process for reversibly storing hydrogen, in which the storage materials used are the alkali metal alanates of the general formula M¹ₚ₍₁₋ₓ₎M²ₚₓAlH₃₊ₚ M¹=Na, K; M²=Li, K; 0≦x≦0.8; 1≦p≦3. To improve the hydrogenation/dehydrogenation kinetics, the alkali metal alanates are doped with transition metals or compounds thereof in catalytic amounts. The storage materials disclosed in WO01/68515 are obtained by a so-called direct synthesis in which the alkali metals or hydrides thereof, aluminum and transition metals or compounds thereof are converted under hydrogen pressure and at elevated temperature. The hydrogenations are performed at temperatures between 100-165° C., in the region of 120 bar of H₂ pressure over 4 to 24 h. The first hydrogenation requires a time of 24 h.

The storage materials are prepared by reacting solids with a gas, optionally under elevated temperature, which is very complicated from a process technology point of view.

The synthesis of further hydride compounds, such as alkaline earth metal hydrides, is also, for example, very complicated. For the synthesis of calcium hydride, nowadays, a process in which calcium metal is reacted with hydrogen gas at temperatures of 400° C. under standard pressure is used in industry. The resulting calcium hydride has a purity of 90-96%, unconverted calcium metal constituting the main impurity. In addition, calcium oxide is a further impurity. This commercial preparation method is energy-intensive, since the material has to be heated to a temperature of 400° C., and is therefore associated with considerable costs. On the other hand, it is necessary to work under rigorous anaerobic conditions in order to rule out oxidation of the calcium to the oxide at relatively high temperatures and, secondly, to prevent the reaction of oxygen and hydrogen (oxygen/hydrogen explosion).

It is thus an object of the present invention to provide a process with which the efficiency in the reaction of solids with gases can be improved or the reaction time can be shortened.

Especially in the case of preparation of hydrogen storage materials, it is a further object also to improve the storage capacity of the materials, their capacity to release hydrogen again and the cycle stability.

It has now been found that, surprisingly, a significant shortening in the reaction times between the solid and the gas can be achieved when grinding of the solids takes place under pressure during the reaction. It is also possible to perform the reactions at lower reaction temperatures than are customary in the processes known from the prior art.

The present invention accordingly provides a process for synthesizing compounds in which solids are reacted with one or more gases, which is characterized in that the solids are ground above atmospheric pressure in the presence of the gas.

The process according to the invention contacts the gas intensively with the solid, such that the reaction between the reactants proceeds rapidly, which leads to a shortening of the reaction time. The grinding achieves a homogeneous distribution of gas and solid; in addition, new interfaces in the solid are broken open, as a result of which new contact areas between the solid and gas reactants form.

With the process according to the invention, it is possible to perform any reactions between organic and/or inorganic solids and gaseous components. Suitable gases are all known gases which can be used at the reaction temperature and the given pressure. Examples include H₂, O₂, N₂, CO₂, SO₂, SO₃, BH₃, Cl₂, F₂, etc.

According to the invention, the reaction between solid and gas is performed at a gas pressure which is above atmospheric pressure, especially above 10×10⁵ Pa. The gas pressure is preferably between 20×10⁵ and 150×10⁵ Pa, more preferably between 50×10⁵ and 150×10⁵ Pa, especially between 50×10⁵ and 100×10⁵ Pa.

Typically, the reaction is effected in a pressure reactor which is suitable as a grinding cup for a high-energy grinder. In a preferred embodiment, the starting substances are ground, the mills used being those which comminute the material being ground using grinding bodies, for example vibratory mills, stirred mills, stirred ball mills, ball mills, etc., and the grinding vessel can be operated under gas pressure.

In a further preferred embodiment, the grinding vessels used are those which can be operated under pressure and are simultaneously heatable. The grinding of the solid generally generates heat by mechanical means, which can lead to a rise in the temperature in the reaction chamber. This temperature rise generated by the grinding operation is sufficient as the reaction temperature in most cases.

In a preferred embodiment, the process according to the invention is used to prepare hydrogen storage materials, especially aluminum (alkali metal/alkaline earth metal) hydrides. In this embodiment, the solid starting compounds used are aluminum metal, alkali metal/alkaline earth metal and/or alkali metal hydrides/alkaline earth metal hydrides, and the gaseous component used is H₂. As a result of the process according to the invention, it is possible in the preparation of hydrogen storage materials not only to significantly shorten the hydrogenation time, but also to obtain storage materials with improved hydrogenation and dehydrogenation properties.

The starting substances used in one possible embodiment may be the alkali metals and alkaline earth metals and their hydrides and aluminum powder of a wide range of different particle sizes, to which one or more dopants are added in a manner known per se.

In a further embodiment of the process according to the invention, catalysts, preferably transition metal catalysts, are added to the reaction mixture. These catalysts improve the hydrogenation and dehydrogenation properties of the hydrogen storage materials. These catalysts are added to the starting components directly at the start of the process in the process according to the invention. In this embodiment, the process according to the invention has the advantage that one synthesis step is saved, since doping and reaction with the gas, the hydrogenation here, takes place during the grinding, and a particularly homogeneous distribution of the dopant in the reaction product, for example in the storage material, is also achieved.

The transition metal catalysts are preferably selected from transition metal compounds of the third to fifth group of the periodic table and compounds of iron, nickel and rare earth metals and combinations thereof, especially their alkoxides, halides, hydrides, organometallic and intermetallic compounds.

In a preferred embodiment, it is also possible to use mixtures of alkali metals/alkaline earth metals or hydrides thereof and aluminum in combination with transition metals or compounds thereof as dopants. As a result, it is possible to obtain hydrogen storage materials such as Na₂LiAlH₆ by a single synthesis step within a very short time. It is also possible to use mixtures of two or more alkali metals and alkaline earth metals or hydrides thereof as the cation source in a further embodiment.

In the storage materials prepared in accordance with the invention, alkali metal/alkaline earth metal and aluminum are present preferably in a molar ratio of 3.5:1 to 1:1.5, the catalysts used for doping in amounts of 0.1 to 10 mol % based on the alkali metal alanates/alkaline earth metal alanates, more preferably in amounts of 0.5 to 5 mol %. An excess of aluminum based on the formula I has an advantageous effect.

The invention further relates to a mill with a grinding space which accommodates the material being ground.

Commercial mills, for instance vibratory mills, gravitational ball mills, etc., have one or more dust-tight grinding spaces in which the material to be comminuted and optionally a multitude of grinding bodies are accommodated. The actual grinding operation is effected, for example in the case of ball mills, by the spherical grinding bodies which move within the grinding space in the presence of ambient air, which is why such mills are unsuitable for performing the process according to the invention, in which the grinding operation in the presence of a process gas having a considerable gas pressure.

It is therefore a further object of the invention to provide a mill in which the grinding operation can be performed in the presence of a process gas even above atmospheric pressure.

To solve this problem, in a mill with the features specified above, it is proposed that the grinding space be closable in a pressure-tight manner even against high internal pressures.

As a result of the pressure-tight closability of the grinding space, the grinding operation of the solids to be ground can be effected in the presence of a selected process gas above atmospheric pressure, as required to perform the process according to the invention.

In an advantageous embodiment, the grinding space is formed by a pressure vessel and a lid which seals it in a pressure-tight manner, such that the grinding space is sealed pressure-tight with the lid on. In order to fill the grinding space with material to be ground or to remove it after the grinding operation has ended, the lid is removed. It is also possible in the case of, for example, ball mills to remove the lid and to adjust the number of balls or, by exchanging them, also their geometry to the solids to be ground.

In order to provide sufficient pressure resistance of the pressure vessel, it is advantageous when the pressure vessel is strengthened mechanically and is clamped against the lid by means of a pressure sleeve surrounding it. Such a sleeve is advantageous from two points of view, since it firstly enables clamping of the pressure vessel against the lid without mechanically weakening it by means, for example, of threaded bores. On the other hand, it brings about a wall thickness strengthening of the pressure vessel, which additionally increases its stability.

A preferred embodiment envisages that the mill is provided with transducers which detect the grinding conditions within the grinding space, as a result of which the grinding conditions can be monitored by the user or a downstream electronic system. Advantageously, the transducers should include a pressure sensor and a thermoelement, since the pressure and the temperature are essential influencing parameters of the process according to the invention.

A particularly preferred embodiment envisages transmitting the data detected by the transducers wirelessly to an evaluation unit by means of an antenna arranged on a grinding cup, as a result of which a transmission of the data which is simple from a construction point of view from the transducers which rotate with respect to the evaluation unit is effected. In particular, it is not necessary to provide electrical lines between the rotating transducers and the fixed evaluation unit.

From a construction point of view, it is advantageous to arrange the transducers in or on the lid. In the case of such an arrangement, it is also possible, for example, to provide several lids with different transducers and then to select one transducer suitable for the particular grinding operation, for example with reference to the measurement range or the measurement resolution.

In an advantageous embodiment, the lid is provided with a valve for the supply of process gases. It is possible to supply the process gases required through this valve and to regulate their gas pressure in a simple manner.

Advantageously, the pressure vessel and the lid together with a casing form a grinding cup rotatable about an axis of rotation. Such grinding cups may be used, for example, in planetary ball mills or gravitational ball mills which are formed from a rotating sunwheel and one or more grinding cups. The grinding cups are rotatable about their axis of rotation close to the circumference of the rotating sunwheel, as a result of which the relative motion, required for the grinding operation, of the balls present in the pressure vessel of the grinding cup relative to the inner jacket surface of the pressure vessel is achieved.

In a further advantageous embodiment, it is proposed that a voltage supply for the transducers is arranged in or on the grinding cup. This is because a voltage supply arranged in or on the grinding cup allows a simple construction of the mill, since it is possible to dispense with the electrical contacting of the transducers which rotate with the grinding cup to a fixed current source.

To regulate the internal pressure in the interior of the grinding cup, it is advantageous to configure the valve so as to be controllable by means of a control device supplied with current via the voltage supply, in order to be able to undertake a pressure adjustment in this way even during the grinding operation.

Further details and advantages of the invention are explained with reference to the description of the accompanying drawing which follows, which shows the structure of an inventive mill using the example of a grinding cup of a planetary ball mill. In the drawing,

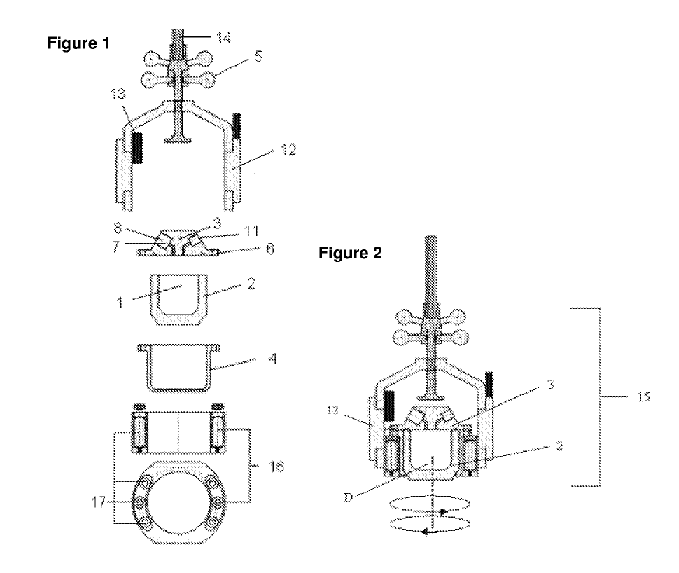

FIG. 1 shows an explosion view of a grinding cup of an inventive planetary ball mill,

FIG. 2 shows a section of the grinding cup from FIG. 1 in the assembled state and

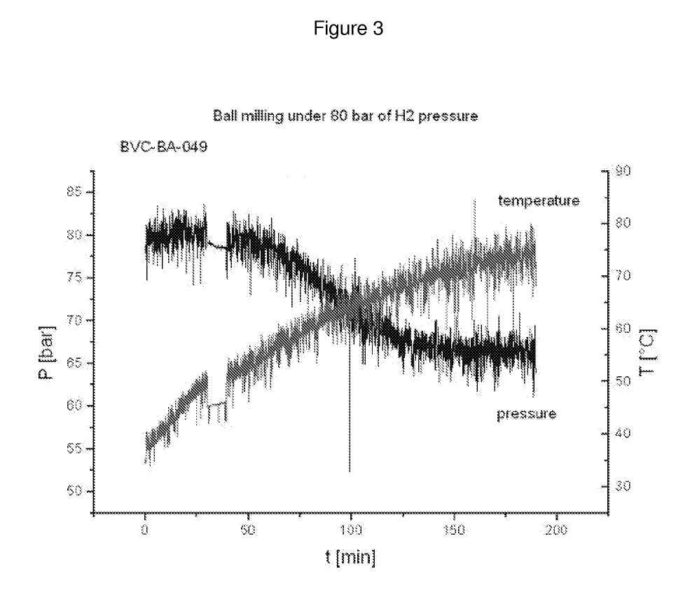

FIG. 3 shows a plan view of the voltage supply from FIG. 1 from the direction designated by III.

FIG. 2 shows the grinding cup 15 of an inventive planetary ball mill in a section view. The grinding cup 15 rotates in a customary manner about the vertical axis of rotation D, and is also mounted eccentrically on a sunwheel which is not shown in the figures and likewise rotates. The principle of operation of such planetary ball mills is known and is based on the relative motion between grinding cup 15 and sunwheel, which has the consequence of movement of the spherical grinding bodies 9 within the grinding space 1. As a result of the impact and frictional forces thus generated between material being ground 10 and grinding bodies 9, there is thus comminution of the material being ground 10.

As can also be taken from FIG. 1 and FIG. 2, the grinding space 1 is delimited by a pot-shaped pressure vessel 2 and a lid 3 which closes it. The pressure vessel 2 is manufactured from a material having a comparatively high strength and is strengthened at its circumference additionally by a separate pressure sleeve 4 in order in this way to be able to withstand the gas pressure P₁ which exists in the grinding space 1 and is significantly above atmospheric pressure P₂This is because the performance of a process according to the invention requires gas pressures P₁ above atmospheric pressure, especially above 10×10⁵ Pa. In the mill, it should preferably be possible to employ gas pressures between 20×10⁵ and 150×10⁵ Pa, more preferably between 50×10⁵ and 150×10⁵ Pa, especially between 50×10⁵ and 100×10⁵ Pa. The pressure vessel is therefore clamped pressure-tight against the lid 3. The clamping means are flanges 5 which can be connected to one another and are molded onto the pressure sleeve 4 surrounding the pressure vessel 2 and onto the lid 3 with a seal 6 in between.

Within the lid 3 is arranged a valve 11, through which process gases are supplied into the grinding space 1 and the gas pressure P₁ of the grinding space 1 can thus be adjusted.

As can best be seen in FIG. 1, the lid 3 is provided with transducers 7, 8 in the form of a pressure sensor 7 and of a thermoelement 8, with which the pressure P₁ existing in the grinding space and the temperature there are detected continuously. For the voltage supply to the transducers 7, 8, a voltage supply 16 is integrated into the grinding cup 15. As shown in FIG. 1 in combination with FIG. 3, this consists of a total of six batteries 17 arranged symmetrically on the circumference of the pressure vessel 2 to prevent unbalanced masses. The voltage supply 16 surrounds the pressure vessel 2 and the pressure sleeve 4 in the form of a ring.

The transducers 7, 8 are connected via electrical wires not shown in detail in the figures to a transmitter 13, which converts the output signals of the transducers 7, 8 to a signal transmittable wirelessly by means of an antenna. By means of the antenna 14 which is secured on a casing 12 connected in a rotationally fixed manner to the pressure vessel 2, the measurements detected in the grinding space 1 of the rotating grinding cup 15 are sent to an external, fixed evaluation unit or electronic system.

The antenna 14 can, though, function not only as a transmitter but also as a receiver. When, for example, the measured pressure values P₁, for example owing to rising temperatures, exceed a desired level, the operator or the evaluation unit can transmit a signal which is captured by the antenna 14 and, via an appropriate electronic system and a regulator not shown in the figures, brings about an adjustment of the pressure P₁ by briefly opening the valve 11. To this end, the valve 11 is provided with a suitable adjustment device which draws its supply voltage again via the batteries 17.

### EXAMPLE 1

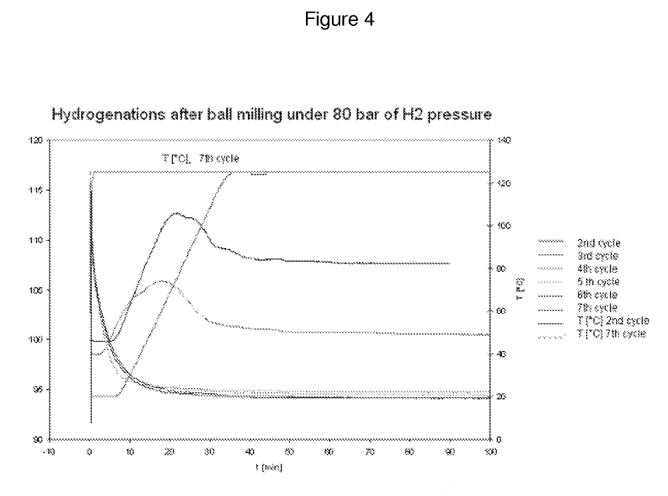

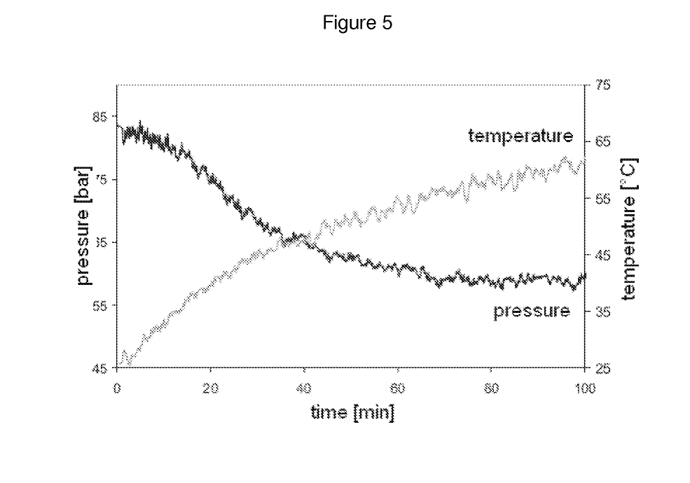

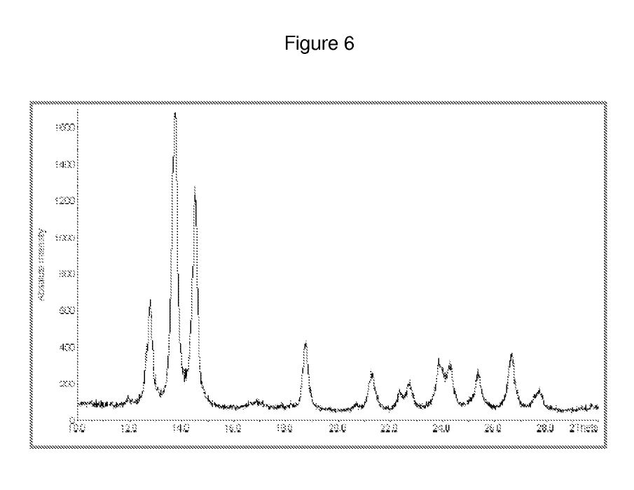

Sodium hydride (0.84 g, mol) and Al powder (0.94 g, mol) were mixed with 4 mol % of TiCl₃ and ground under 80 bar of hydrogen pressure in a high-energy mill (Fritsch Pulverisette P8) with 7×13 g balls at a rotational speed of 500 revolutions/min. To control the reaction, pressure and temperature were registered in a grinding cup of the type described during the grinding process (FIG. 3). The resulting material is dehydrogenated and hydrogenated several times. Hydrogenation and dehydrogenation cycles exhibit identical behavior and afford a storage capacity of 3.6% by weight (FIG. 4). (Conditions: dehydrogenation 120/180° C., hydrogenation 100 bar, 120° C.)

### EXAMPLE 2

2 g of calcium metal (Aldrich 99.9%) are ground under 85 bar of hydrogen pressure in a high-energy mill (Fritsch Pulverisette P8) with 7×13 g balls at a rotational speed of 500 revolutions/min. To control the reaction, pressure and temperature are registered in a grinding cup of the type as described herein during the grinding process (FIG. 1).

The hydrogenation has ended after approx. 1 h and affords highly reactive calcium hydride which, unlike commercial products, ignites spontaneously on ingress of air.

An X-ray powder diffractogram of the resulting material is shown by FIG. 2. Here, only calcium hydride can be observed; impurities or unconverted calcium metal cannot be detected.

### REFERENCE NUMERALS

1 grinding space
2 pressure vessel
3 lid
4 pressure sleeve
5 securing elements
6 seal
7 transducer, pressure sensor
8 transducer, thermoelement
9 grinding body
10 material to be ground
11 valve
12 casing
13 transmitter
14 antenna
15 grinding cup
16 voltage supply
17 battery

1. A process for synthesizing a compound comprising reacting solids with one or more gases, said process further comprising grinding the solids at a pressure above atmospheric pressure in the presence of the one or more gases.

2. The process as claimed in claim 1, wherein the one or more gases are selected from the group consisting of O₂, N₂, CO₂, SO₂, SO₃, BH₃, Cl₂ and F₂.

3. The process as claimed in claim 1, wherein the grinding is performed at a pressure of from 10×10⁵ to 150×10⁵ Pa.

4. The process as claimed in claim 1, wherein the grinding is effected in a mill in which the the solids are comminuted using grinding bodies.

5. The process as claimed in claim 4, wherein the mill is selected from the group consisting of vibratory mills, stirred mills, stirred ball mills, and ball mills.

6. The process as claimed in claim 1, wherein the solids are a mixture comprising aluminum metal, alkali metal/alkaline earth metal and/or alkali metal hydrides/alkaline earth metal hydrides, and the one or more gases is or comprises H₂.

7. The process as claimed in claim 6, wherein the compound synthesized is a hydrogen storage material.

8. The process as claimed in claim 6, wherein the compound synthesized is CaH₂.

9. The process as claimed in claim 1, wherein said reacting occurs in the presence of one or more transition metal catalysts.

10. The process as claimed in claim 9, wherein the transition metal catalysts comprise transition metal compounds of the third to fifth group of the periodic table, and compounds of iron, nickel and rare earth metals and combinations thereof.

11. A mill comprising a grinding space to accommodate a material to be ground, wherein the grinding space can be sealed in a pressure-tight manner even against high internal pressures (P₁).

12. The mill as claimed in claim 11, wherein the grinding space is formed by a pressure vessel and a lid that seals the pressure vessel in a pressure-tight manner.

13. The mill as claimed in claim 12, wherein the pressure vessel is strengthened mechanically and is clamped against the lid by a pressure sleeve surrounding the pressure vessel.

14. The mill as claimed in claim 13, wherein a seal is arranged between the lid and the pressure vessel.

15. The mill as claimed in claim 11, which further comprises transducers that detect grinding conditions within the grinding space.

16. The mill as claimed in claim 15, wherein the transducers comprise a pressure sensor and a thermoelement.

17. The mill as claimed in claim 16, wherein data detected by the transducers are transmitted wirelessly to an evaluation unit by means of an antenna arranged on a grinding cup.

18. The mill as claimed in claim 17, wherein the transducers are arranged in or on the lid.

19. The mill as claimed in claim 12, wherein the lid comprises a valve for the supply of process gases.

20. The mill as claimed in claim 12, wherein the pressure vessel and the lid together with a casing form a grinding cup rotatable about an axis of rotation.

21. The mill as claimed in claim 20, wherein a voltage supply for transducers is arranged in or on the grinding cup.

22. The mill as claimed in claim 19, wherein the valve is controllable via a control device supplied with current via a voltage supply.
